(19) United States
(12) Patent Application Publication
(10) Pub. No.: US 2022/0264521 A1
(43) Pub. Date: Aug. 18, 2022

(54) PAGING OPTIMIZATION BASED ON PROXIMITY OF MOBILE DEVICES

(71) Applicant: IPCom GmbH & Co. KG, Pullach (DE)

(72) Inventors: Andreas SCHMIDT, Braunschweig (DE); Achim LUFT, Braunschweig (DE); Maik BIENAS, Schoeppenstedt (DE); Martin HANS, Bad Salzdetfurth (DE)

(73) Assignee: IPCom GmbH & Co. KG, Pullach (DE)

(21) Appl. No.: 17/597,558

(22) PCT Filed: Jul. 17, 2020
(86) PCT No.: PCT/EP2020/070303

§ 371 Date: Jan. 11, 2022

(30) Foreign Application Priority Data
Jul. 17, 2019 (EP) 19186812.4

(51) Int. Cl. H04W 68/02; H04W 68/00; H04W 74/08

(52) U.S. Cl. CPC H04W 68/02; H04W 92/18; H04W 74/0841; H04W 68/005

(57) ABSTRACT

The present invention provides a method of performing a paging action directed to a second user equipment, UE, device in a mobile communications system, the method comprising transmitting a configuration message from a first base station to a first UE device to configure the first UE device to transmit a paging indicator at a predetermined time if it is determined that a geographical condition is satisfied; and transmitting a paging message from one of the first base station and a second base station to the second UE device after the paging indicator has been transmitted.

The present invention relates to paging procedures in cellular communication systems, for instance in a cellular communication system operating according to 3GPP's 4G-LTE suite of specifications or its successor technology which is commonly referred to as 5G-NR.

In 4G-LTE, the radio access network (RAN) consists of base stations called eNBs, providing user plane (PDCP/RLC/MAC/PHY) and control plane (RRC) protocol terminations towards the mobile communication devices (UEs). The eNBs are interconnected with each other by means of an X2 interface. The eNBs are also connected by means of an S1 interface to a core network (CN), more specifically to a mobility management entity (MME) taking care of C-Plane traffic by means of the S1-MME interface and to the serving gateway (S-GW) taking care of U-Plane traffic by means of the S1-U interface. The S1 interface supports a many-to-many relation between MMEs/S-GWs and eNBs.

Each base station of the cellular communication system may control communication over the air interface within its geographic coverage area, namely in its radio cell. When the mobile communication device (UE) is located in coverage of a radio cell and camping on it (in other words, when it is registered with the radio cell providing coverage) it may communicate with the base station controlling that radio cell. When a call is initiated by the user of the mobile communication device or a call is addressed to the mobile communication device, radio channels may be set up between the mobile communication device and the base station controlling the radio cell in which the mobile communication device is located.

As the mobile communication device continues to move throughout the coverage area of the cellular communication system, control of the call may be transferred between neighbouring radio cells. The transfer of calls from one radio cell to another radio cell is usually referred to as handover (or handoff). Handover is usually based on measurements (e.g., on different overlapping and/or neighbouring radio cells) performed by the UE as configured by the network.

In this context, the term “call” is intended to cover a wide variety of use cases where user data is being exchanged unidirectionally or bidirectionally over the air interface as part of an active connection between a serving base station and a mobile communication device. It can for example be a voice call, a data call, internet data traffic, and much more.

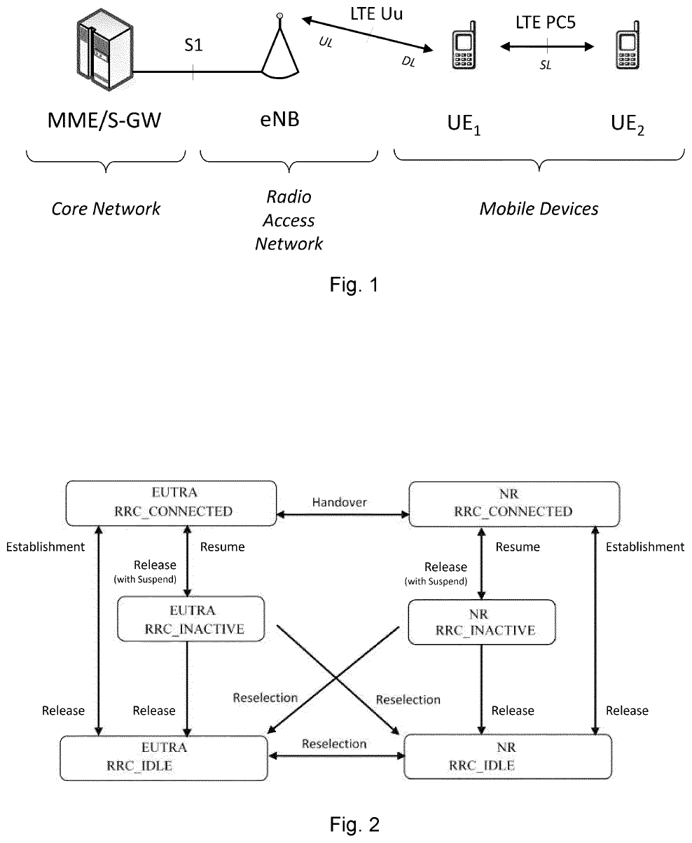

A further interface for direct device-to-device communication (D2D) was defined in 3GPP. It is shown in FIG. 1 using 4G-LTE terminology. The same interface exists in 3GPP's successor technology 5G-NR, too.

Two mobile communication device (UEs) that are residing within or outside of coverage of the system's radio cells may communicate with each other to enable certain services (or applications), such as “public safety” or “vehicle to vehicle communication”.

As direct device-to-device communication has to work in regions where network coverage cannot be guaranteed, 3GPP has come up with three different scenarios:

(i) in-coverage scenario: The network controls the resources used for D2D communication.

(ii) out-of-coverage scenario: The UE uses resources which are preconfigured, either in the mobile device or in the USIM of the UICC card. However, the term out-of-coverage has to be interpreted carefully. It does not mean that there is no coverage at all. It rather means that there is no coverage on the frequency used for D2D communication, although the UE might be in coverage on a different carrier for cellular traffic.

(iii) partial-coverage scenario: The UE out-of-coverage uses the preconfigured values, whereas the UE in coverage gets its resources from the base station. A careful coordination between the network and the preconfigured values is necessary in order to enable communication and to limit the interferences to UEs residing at cell boundary near an out-of-coverage UE.

In conventional cellular traffic e.g., over the LTE Uu air interface, the eNB communicates with the UE in an uplink (UL) direction (i.e., from the handset to the cell tower) and in a downlink (DL) direction (from the cell tower to the handset). This concept was extended for the various direct device-to-device communication use cases with the introduction of the sidelink (SL) for the LTE PC5 air interface.

FIG. 2 shows a radio resource control (RRC) protocol state diagram according to 3GPP TS 38.331. It also illustrates the inter-RAT mobility support between 4G-LTE (depicted on the left) and 5G-NR (depicted on the right).

When an RRC connection has been established a mobile communication device (UE) is either in RRC_CONNECTED state or in RRC_INACTIVE state of operation. If this is not the case, i.e. no RRC connection is established, the UE is in RRC_IDLE state. The RRC states can further be characterized as follows:

RRC_IDLE:
A UE specific DRX may be configured by upper layers;
Mobility is UE controlled (based on network configuration);
The UE monitors DL control channels in order to detect paging indicators;
The UE performs neighbour cell measurements and cell (re-)selection;
The UE acquires system information and can send SI request (if configured).

RRC_INACTIVE:
A UE specific DRX may be configured by upper layers or by RRC layer;
Mobility is UE controlled (based on network configuration);
The UE stores the “UE Inactive” Access Stratum (AS) context;
A RAN-based notification area is configured by RRC layer;
The UE monitors DL control channels in order to detect paging indicators;
The UE performs neighbour cell measurements and cell (re-)selection;
The UE performs RAN-based notification area updates;
Acquires system information and can send SI request (if configured).

RRC_CONNECTED:
The UE stores the “UE Active” Access Stratum (AS) context;
Unicast data to/from UE can be transferred;
At lower layers, the UE may be configured with a UE specific DRX;
For UEs supporting CA: One or more SCells can be aggregated with the SpCell, for increased bandwidth;
For UEs supporting DC: An SCG can be aggregated with the MCG, for increased bandwidth;
Mobility is network controlled;
The UE monitors DL control channels in order to detect paging indicators;
The UE monitors DL control channels in order to detect resource assignments;
The UE provides channel quality and feedback information;
The UE performs neighbour cell measurements and measurement reporting;
The UE acquires system information.

Paging is a mechanism in which the infrastructure side tells the mobile communication device “I have something for you”. In most cases, the paging process is initiated when a mobile communication device is in a state of reduced energy consumption (e.g., residing in RRC_IDLE or RRC_INACTIVE mode of operation). But paging may also happen while the UE is having an ongoing connection with its serving base station (e.g., while residing in RRC_CONNECTED mode of operation).

In earlier wireless communication systems, such as 3G-UMTS, a special physical channel is provided in the downlink for a mobile communication device to detect paging messages. This Paging Indicator Channel was specifically designed to enable the mobile communication device to wake up its receiver periodically (for a very short period of time, in order to minimize the impact on battery life) for detecting a paging indicator (that is typically assigned to a group of UEs). The mobile communication device would then keep its receiver switched on to receive a longer message indicating the exact identity of the UE being paged.

In communication systems according to 4G-LTE and 5G-NR there is no such separate physical channel for this purpose; instead the PDSCH (physical downlink shared channel) is used for the paging message and the indication is provided via the PDCCH (physical downlink control channel). The PDCCH signalling is already very short in duration, and therefore the impact of monitoring the PDCCH from time to time on battery life is low. The normal PDCCH signalling can thus be used to carry the (equivalent of a) paging indicator, while the detailed paging information is carried on the PDSCH in a resource block indicated by the PDCCH. Paging indicators sent on the PDCCH use a single fixed identifier called the P-RNTI (paging radio network temporary identity). Rather than providing different paging identifiers for different (groups of) UEs, different (groups of) UEs are configured to monitor different sub-frames (their paging occasions) for their paging messages. A paging message usually consists of several paging records (up to 32), each of which is destined for a particular UE. A UE can be identified by a UE-identifier that is carried inside the paging message. This in turn means that all UEs that have picked up a paging indicator (in their respective paging occasion) are required to receive, decode and analyse the entire paging message, even if there is no paging record included for them. In real life deployments the number of UEs sharing a paging occasion can be quite high (i.e. much larger than 32).

The paging procedure can be initiated in the following scenarios:
to transmit paging information to a UE residing in RRC_IDLE or RRC_INACTIVE to trigger the RRC Connection Establishment or RRC Connection Resume procedure (cf. FIG. 2);
to inform UEs in all three RRC states about a SI (system information) change;
to inform UEs in all three RRC states about PWS (public warning system) notifications.

Paging means the mobile communication device is expected to monitor constantly certain downlink resources on the PDCCH in order to check whether the networking is sending out a paging indicator. This paging indicator is indicating an imminent transmission of the corresponding paging message on the PDSCH.

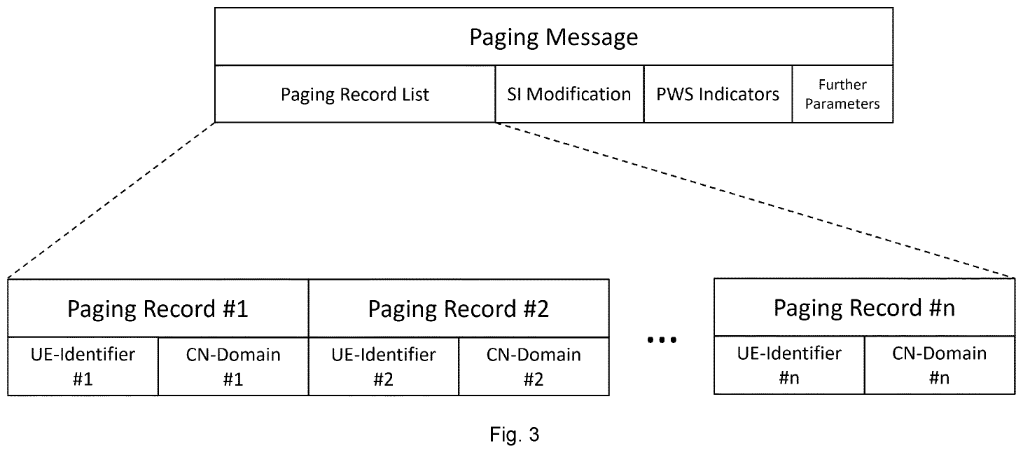

In the context of the present invention the term “paging data” comprises the “paging indicator” (which may be present in form of a P-RNTI on PDCCH) and the actual “paging message” (which may be transmitted on the PDSCH and may contain several “paging records” for different UEs). According to the state-of-the art, the “paging message” always follows the “paging indicator” in the PDSCH region of the same subframe. A paging record is a dedicated set of information destined for a particular mobile communication device. FIG. 3 shows the structure of a known paging message as defined for 4G-LTE.

Up to 32 paging records can be included in a paging message. Each paging record may consist of a UE-Identifier (e.g., IMSI or S-TMSI) and a CN-Domain indicator (e.g., “CS” for circuit switched or “PS” for packet switched). The remaining information elements relate to system information updates (SI modification) or various public warning system (PWS) indicators followed by further optional information elements (depending on the release number of the specification) such as parameters for controlling access barring, inter-frequency redistribution, or indication of a BCCH modification for UEs using eDRX.

In some scenarios the structure of the paging message may deviate from the one shown in FIG. 3, in that it only comprises a paging record list. In this case, the indicators for SI modification and PWS are contained in a separate 8-bit word termed “short message” which may be carried (in some types of DCI) on PDCCH.

If a mobile communication device residing in RRC_IDLE or RRC_INACTIVE mode of operation is being paged, the paging data received by the mobile communication device may trigger it to enter a mode of full operation. For example, in case of user data becoming available on the infrastructure side for a mobile communication device (an event called “downlink data arrival”) the mobile communication device in question may be paged to change from RRC_IDLE or RRC_INACTIVE state of operation into RRC_CONNECTED state of operation (cf. RRC Connection Resume or RRC Connection Establishment procedures shown in FIG. 2).

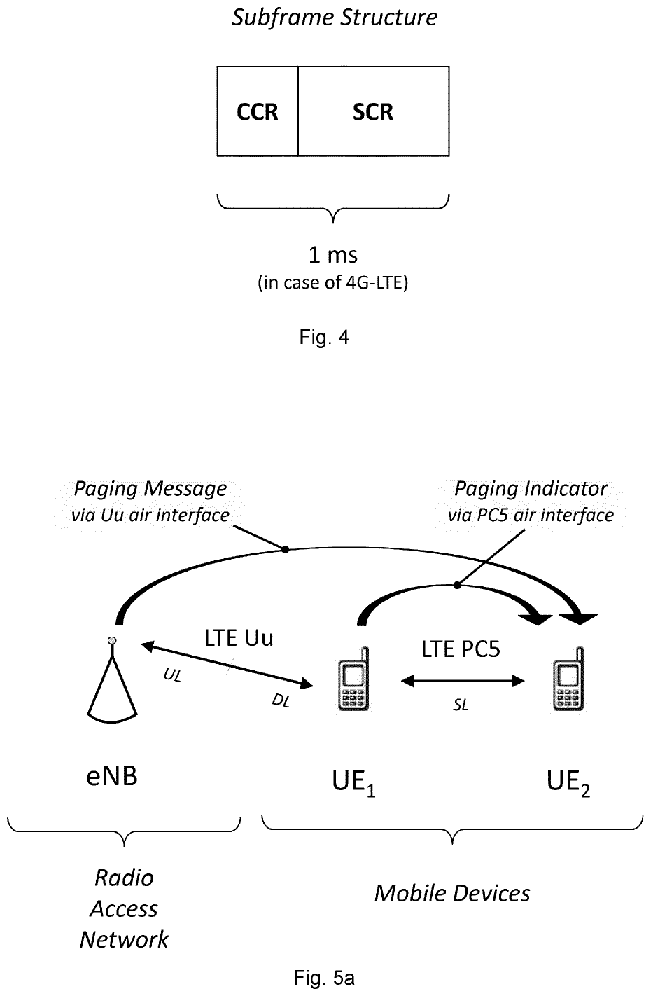

FIG. 4 shows a simplified subframe structure for the downlink (tower to handset) resource grid as used in a wireless communication system according to 4G-LTE. A subframe may comprise two regions, namely a control channel region (CCR) and a shared channel region (SCR). The CCR may (predominantly) contain the PDCCH/PCFICH physical channels while the SCR may (predominantly) contain the PDSCH physical channel. For sake of simplicity, the broadcast channel region (i.e. the region where the PBCH physical channel is located) as well as the synchronization signals (such as P-SS and S-SS) are not shown in FIG. 4. In case of 4G-LTE, ten consecutive subframes build a radio frame with a total length of 10 ms.

Subframes defined for 5G-NR may also contain a CCR and an SCR, but the arrangement of the regions may deviate from the one shown in FIG. 4, as the 5G-NR resource grid generally allows more flexibility.

For example, in 5G-NR the CCR may be represented in form of a control resource set (CORESET) that does not stretch over the entire bandwidth of the carrier. Furthermore, the CCR of 5G-NR may not be arranged to occupy the first OFDM symbols in a given subframe. Nevertheless, the principles of the method described in the following text may be easily adopted to fit 5G-NR.

For an efficient use of radio resources, the paging procedures in 4G-LTE and 5G-NR were designed with the following characteristics:
more than one mobile communication device monitor the same paging occasion on the PDCCH;
the list of paging records in a paging message enables the network to deal with bursts of paging requests, i.e. with an instantaneous high load of paging requests;
blocking of paging (i.e., paging message cannot be sent) can therefore be reduced to a minimum.

From a UE point of view, the reception of a paging indicator at a given paging occasion requires all mobile communication devices allotted to this paging occasion to receive, decode and interpret the entire content of a subsequent paging message, which usually consists of multiple (up to 32) paging records. Going through all these records is an energy consuming process. All mobile communication devices that have received a paging indicator in their respective paging occasion are obliged to perform this process, even if there is no dedicated paging record included for them in the paging message. In state-of-the-art the number of UEs sharing a paging occasion can be quite high (i.e. much larger than 32).

Only the mobile communication devices for which a matching UE-identifier is found in any of the paging records will act on the paging message. It may well be that the majority of mobile communication devices going through the process of receiving, decoding and analysing the contents of the paging message will eventually find that there is no matching paging record for them. These devices have parsed the contents of the paging message in vain. In context of the present invention this is referred to as “false alarm in paging” (FAP).

WO 2017/099837 A1 describes a UE acting as a relay for a remote UE. A processing circuit of the remote UE detects a paging message from an eNodeB of a ProSe network, over an air interface between the eNodeB and the remote UE or through a relay UE of the ProSe network over a PC5 interface between the relay UE and the remote UE.

WO 2018/028279 A1 (EP 3 449 975 A1) describes a technique for discontinuous reception over the PC5 interface, with a relay UE performing a paging addressed to a remote UE.

U.S. Pat. No. 10,117,223 B1 describes a system in which a relay base station can be used to page a device with a donor base station communicating with the relay base station. EP 3 113 548 A1 describes an arrangement in which in order for one UE to connect to another via a D2D sidelink a first UE requests a serving eNB to page a second UE, with a paging conformation being sent by the second UE to the first UE.

The present invention provides a method of performing a paging action directed to a second user equipment, UE, device in a mobile communications system, the method comprising transmitting a configuration message from a first base station to a first UE device to configure the first UE device to transmit a paging indicator at a predetermined time if it is determined that a geographical condition is satisfied; and transmitting a paging message from one of the first base station and a second base station to the second UE device after the paging indicator has been transmitted.

In a further aspect, the invention provides a method of performing a paging action directed to one user equipment, UE, device in a mobile communications system, the method comprising configuring another UE device to transmit a paging indicator when it is determined that the one UE device satisfies a geographical condition; and transmitting a paging message from a base station to the one UE device after the paging indicator has been transmitted.

The invention also provides a UE device which is arranged to receive a paging indicator from another UE device and in response to configure itself to receive a paging message corresponding to the paging indicator from a base station.

Preferred aspects of the invention are provided according to the dependent claims.

An objective of the present invention is to minimize the number of false alarms in paging. This is achieved by exploiting knowledge of proximity of mobile communication devices that are capable of direct device-to-device communication, and by configuring the involved mobile communication devices accordingly. According for this invention the paging indicator is no longer transmitted in the entire coverage area of the radio cell over the Uu air interface. Instead, it is disseminated by selected mobile communication devices over the PC5 air interface to relevant neighbouring mobile communication devices, when proximity has been detected. The neighbouring mobile communication device being paged may then wake-up to receive the subsequent paging message from the base station over the Uu air interface.

According to a first aspect of the present invention a first mobile communication device may be configured to disseminate paging indicators over the PC5 air interface to a second mobile communication device that the network would like to page. The second (paged) mobile communication device will pick up the subsequent paging message from the base station over the Uu air interface. Thus, the two parts forming the paging data (namely “paging indicator” and “paging message”) are decoupled from each other.

A second aspect of the present invention relates to identifying the neighbour relation between the first mobile communication device and the second (paged) mobile communication device. The second mobile communication device could for instance be a stationary or quasi-stationary communication device, the location of which is known to the infrastructure side (at least in certain boundaries). In one embodiment the second mobile communication device is embedded in or attached to an internet-of-things (IoT) device, such as a smart meter, a road side unit, a vending machine, a sensor or an actuator. In another embodiment the second mobile communication device has been configured with a special sleep cycle that may be considerably longer than the sleep cycles of other mobile communication devices in the same cellular communication network.

The configuration procedure of the first mobile communication device to realize the inventive method is a third aspect of the present invention. Preferably the configuration is performed while this communication device is residing in RRC_CONNECTED mode of operation. The configuration may include location information and/or timing information for sending out paging indicators. The former may assist the first mobile communication device in transmitting the paging indicator when it is in proximity of the second mobile communication device that the network would like to page. The latter may assist the first mobile communication device in transmitting the paging indicator to the second mobile communication device at the right point in time (e.g., taking into account sleep cycles of the second mobile communication device).

According to a fourth aspect of the present invention the transmission of paging indicators between neighbouring mobile communication devices (either on sidelink radio resources or on downlink radio resource) is enabled. For this to work without any interference from the PDCCH transmitted from the radio cell, certain refinements for resource coordination are described in a fifth aspect of the present invention.

According to the fifth aspect of the present invention certain portions of the Control Channel Region (CCR) are not used (blanked) by the base station. This is arranged in order to avoid resource conflicts (interference) between subframes transmitted over the PC5 interface by a first mobile communication device and subframes transmitted over the Uu air interface by a base station.

According to a sixth aspect of the present invention a timing relation is defined between the paging indicator (sent according to the fourth aspect described above) and the subsequent paging message (sent over the Uu air interface). Unlike in state-of-the-art deployments, this timing relation may stretch across different subframes (e.g., the control channel region for transmitting the paging indicator and the shared channel region for transmitting the subsequent paging message may no longer reside in the same subframe).

FAP can be reduced by means of the present invention. In detail, the number of mobile communication devices that have to go through the process of receiving, decoding and analysing the contents of a paging message while they are not actually paged can be reduced significantly. This is especially beneficial for IoT devices, such as smart meters, sensors or actuators, that usually come with stringent constraints regarding power consumption.

By exploiting knowledge of proximity of mobile communication devices that are capable of direct device-to-device communication, and by configuring the involved mobile communication devices with location and timing parameters accordingly, the paging procedure can be improved. According to the present invention the paging indicator is no longer transmitted in the entire coverage area of a radio cell over the Uu air interface. Instead, it is disseminated by selected mobile communication devices over the PC5 air interface to relevant neighbouring mobile communication devices, when proximity has been detected. The neighbouring mobile communication device being paged may then wake-up to receive the subsequent paging message from the base station over the Uu air interface.

Preferred embodiments of the invention will now be described, by way of example only, with reference to the accompanying drawings in which:

FIG. 1 shows connections in direct device-to-device communication according to 3GPP;

FIG. 2 shows radio resource control states and state transitions between 4G-LTE and 5G-NR;

FIG. 3 shows an example of a paging message;

FIG. 4 is an example of a subframe structure as defined for 4G-LTE;

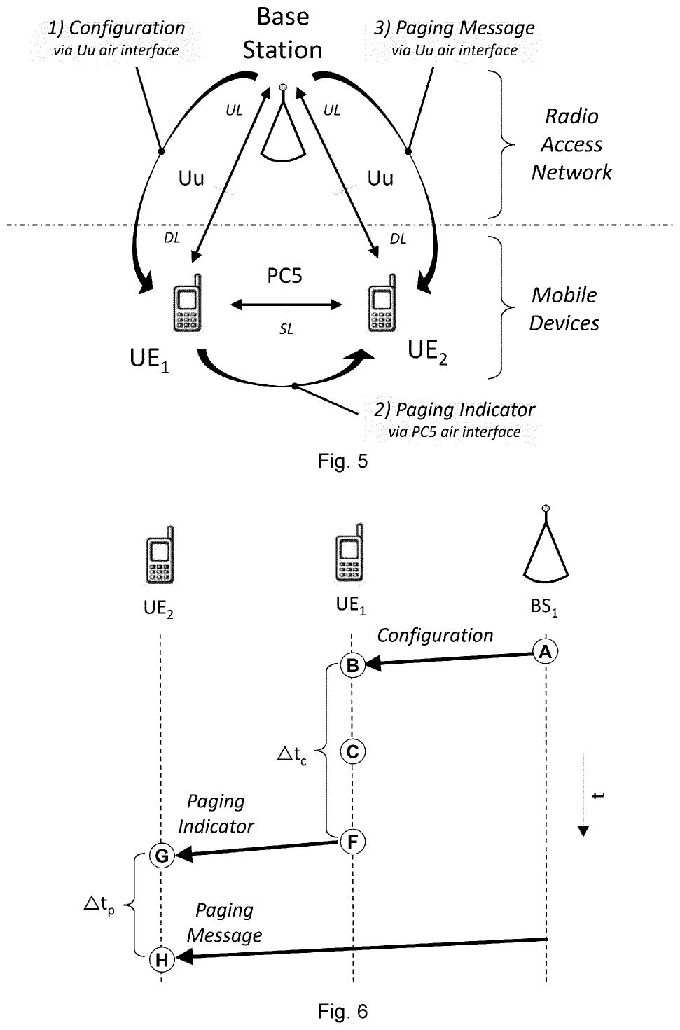

FIG. 5 is a schematic illustration of messages transmitted according to the invention;

FIG. 5a shows a transmission of a paging indicator and a paging message;

FIG. 6 is a message sequence chart showing an implementation of the invention when two UEs are served by the same base station;

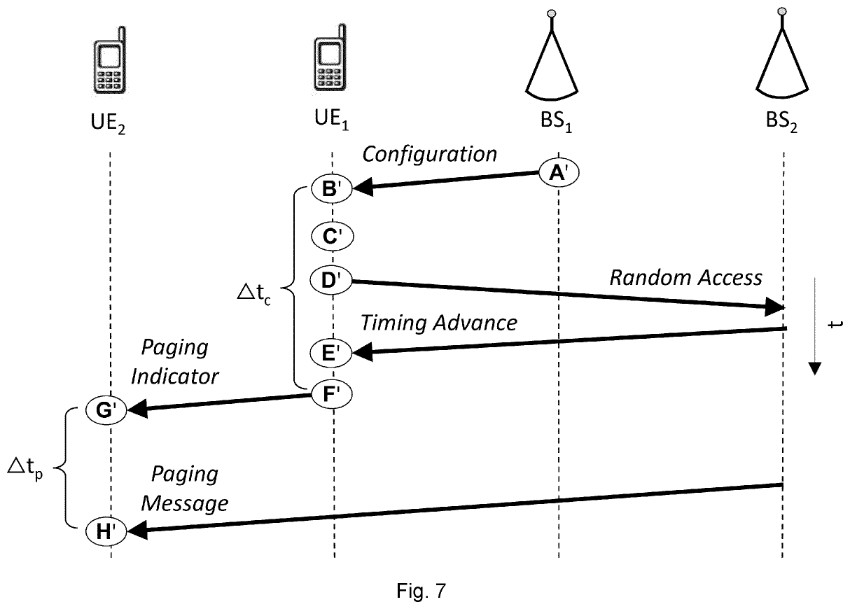

FIG. 7 is a message sequence chart showing an implementation of the invention when two UEs are served by different base stations;

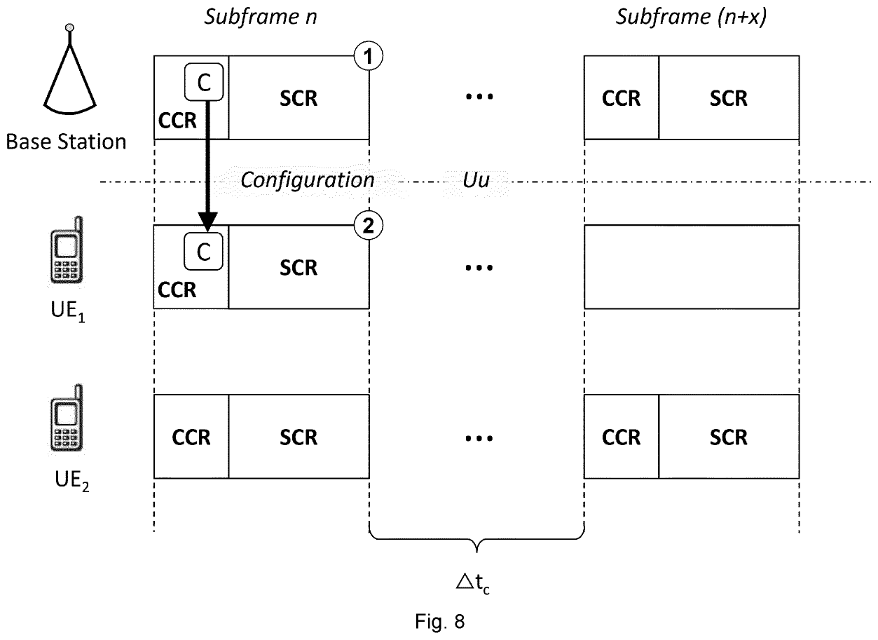

FIG. 8 shows a first configuration option;

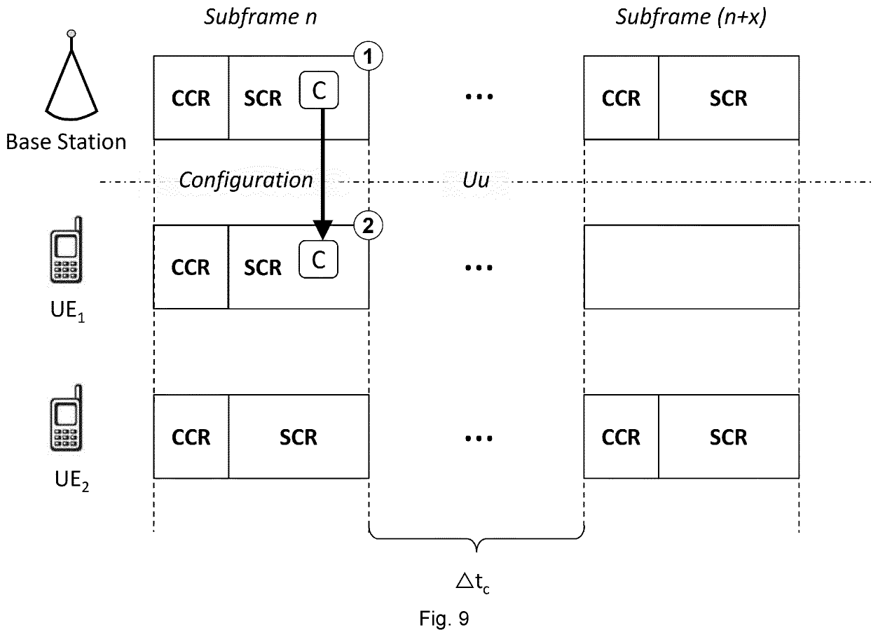

FIG. 9 shows a second configuration option;

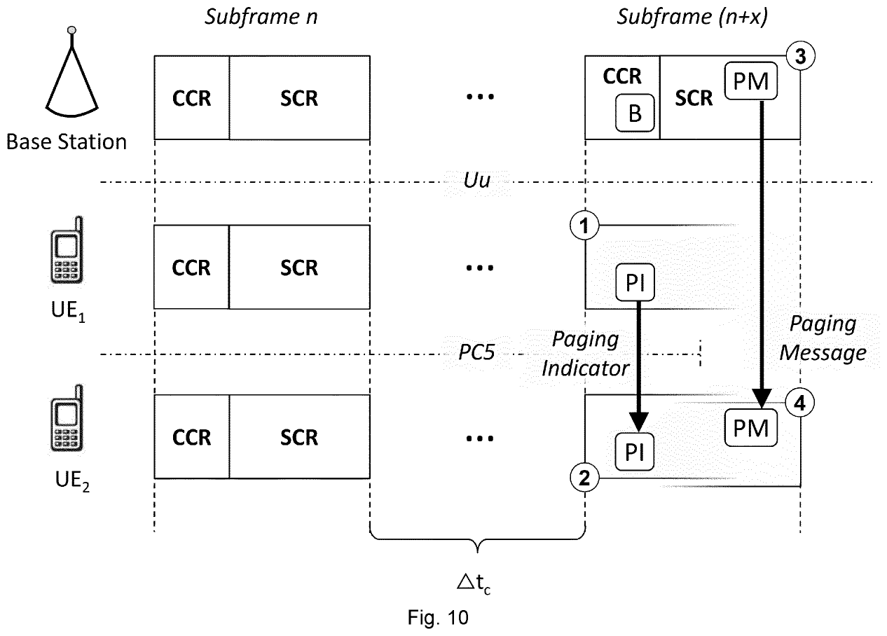

FIG. 10 shows a paging indicator being transmitted in sidelink resources;

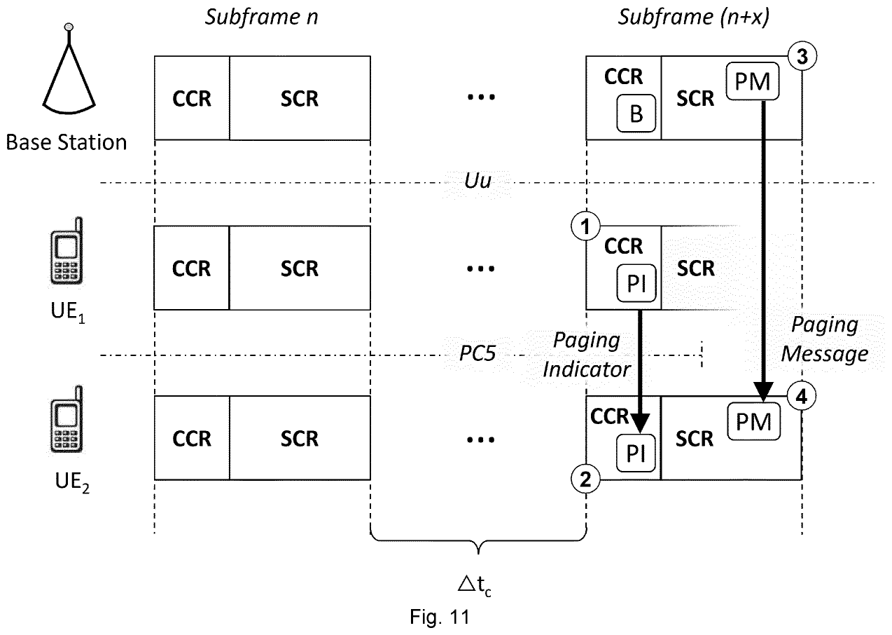

FIG. 11 shows a paging indicator being transmitted in downlink resources; and

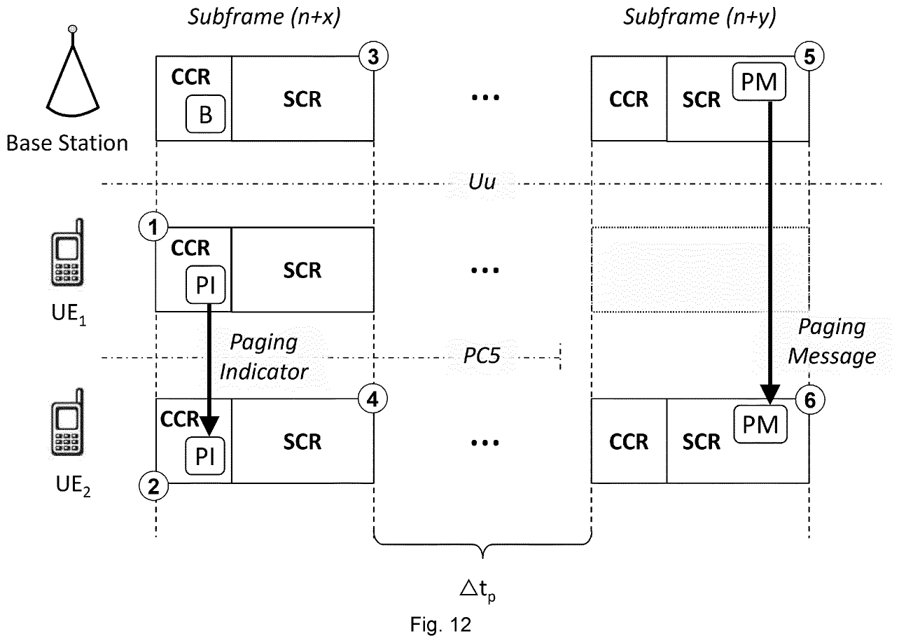

FIG. 12 shows a situation where a paging indicator and a paging message are not sent in the same subframe.

A first aspect of the invention concerns a decoupling of a paging indicator from a paging message.

A first mobile communication device may be configured by the infrastructure side to disseminate paging indicators via the PC5 air interface (either on sidelink radio resources or on downlink radio resources by emulating base station functionality) to a neighbouring second mobile communication device that the network would like to page. The second (paged) mobile communication device will then pick up the subsequent paging message from the base station over the regular Uu air interface.

FIG. 5 depicts how the two parts forming the paging data can be decoupled from each other and sent from different entities: Step 1 represents the configuration process of the mobile communication device that is discussed in more detail in context with the third aspect of the invention below. In step 2 the paging indicator is transmitted by a first mobile communication device (UE₁) and step 3 depicts the transmission of the paging message by a base station. The paging indicator may be transmitted from UE₁ to UE₂ on sidelink resources via the PC5 air interface as shown in FIG. 5a. Another option for transmitting the paging indicator from UE₁ to UE₂ would be to let UE1 provide downlink resources (as the ones used on the Uu air interface) thereby emulating some base station functionality (not shown in FIG. 5). These two different options are discussed in more detail in context with the fourth aspect of the invention below.

FIG. 6 shows a message sequence chart according to an embodiment of the present invention, in which both the first mobile communication device (UE₁) and the second mobile communication device (UE₂) are being served by the same base station. UE₁ may be a regular UE and UE₂ may be an IoT device that may have been configured with sleep cycles that are considerably longer than the sleep cycles of regular communication devices in the same cellular communication network. The sleep cycles of UE₂ may be known to the infrastructure side (and may be stored for example in a memory in a core network entity or in a RAN entity).

At point A of FIG. 6 the base station BS₁ decides (or, receives instructions to do so from the core network) to configure (at least one) UE₁ for transmission of paging indicators to other mobile communication devices that are in proximity (e.g., over the PC5 air interface). For this, the configuration message needs to contain some detailed information about the target mobile communication device (i.e. the one to be paged), for example at least one piece of information related to the target device's sleep cycle, potential wake-up time, configured paging occasions, location data, deployment details, preferred way of paging (e.g., on sidelink resources or on downlink resources) and so on. The configuration message is received by UE₁ at point B. From now on, UE1 is expected to check regularly or continuously the timing and/or location requirements for transmitting paging indicators to neighbouring mobile communication devices. This is indicated at point C in FIG. 6. In some scenarios it may be beneficial to check certain parameters in consecutive order, for example to first check the timing criteria and then (when a paging occasion, or the end of a sleep cycle is approaching) to check the location criteria. For this, UE₁ may compare the output of a GNSS receiver or similar positioning determination module with the location requirement received in the configuration message from the base station. If all these (and potentially further criteria) are met (cf. point F), the UE1 may transmit the paging indicator over the PC5 air interface to mobile communication devices in its vicinity (either on sidelink resources or on downlink resources, as expected by UE₂). In this example, the paging indicator is received by UE₂ at point G. Now, UE₂ is expected to pick up the subsequent paging message transmitted by the base station at the right point in time (e.g., after a relative amount of time tₚ). The paging message is received by UE₂ at point H. It can now be processed, and a matching paging record can be found. Thus, further activities (such as random access attempts to base station BS₁) can be initiated.

FIG. 7 shows a message sequence chart according to another embodiment of the present invention, where the first mobile communication device (UE₁) and the second mobile communication device (UE₂) are being served by different base stations. Again, UE₁ may be a regular UE and UE₂ may be an IoT device that may have been configured with sleep cycles that are considerably longer than the sleep cycles of regular communication devices in the same cellular communication network. The sleep cycles of UE₂ may be known to the infrastructure side (and may be stored for example in a memory in a core network entity or in a RAN entity).

At Point A′ of FIG. 7 the base station BS₁ decides (or, receives instructions to do so from the core network or from other RAN nodes, such as base station BS₂) to configure (at least one) UE₁ for transmission of paging indicators to other mobile communication devices that are in proximity (e.g., over the PC5 air interface). In this example scenario the other mobile communication device (i.e. the one to be paged) is served by base station BS₂. The configuration message needs to contain some detailed information about the target mobile communication device, for example at least one of piece of information related to the target device's sleep cycle, potential wake-up time, configured paging occasions, location data, deployment details, preferred way of paging (e.g., on sidelink resources or on downlink resources) and so on. Additionally, the configuration message needs to contain information about the base station serving the other mobile communication device (for example, a base station identifier pointing to BS₂). The configuration message is received by UE₁ at point B′. From now on, UE1 is expected to check regularly or continuously the timing and/or location requirements for transmitting paging indicators to neighbouring mobile communication devices. This is indicated by point C′ in FIG. 7. In some scenarios it may be beneficial to check certain parameters in consecutive order, for example to first check the timing criteria and then (when a paging occasion, or the end of a sleep cycle is approaching) to check the location criteria. For this, UE₁ may compare the output of a GNSS receiver or similar positioning determination module with the location requirement received in the configuration message from the base station. If certain criteria are met (cf. point D′), the UE1 may initiate a random access procedure towards base station BS₂ in order to get knowledge of the timing advance (TA) value, that is used for communication between base station BS₂ and UE₂. The random access response message containing TA₁ is received by UE₁ in point E′. We are assuming here, that the distance between UE₁ and UE₂ is relatively small (e.g., in the range of 100 meters or less) so that the timing advance value for communication between base station BS₂ and UE₁ (TA₁) and the one for communication between base station BS₂ and UE₂ (TA₂) is the same or at least very similar. When all transmission criteria (as defined in the configuration message) are met the UE₁ may calculate the exact time for transmitting the paging indicator to mobile communication devices in its vicinity (cf. point F′), taking into account the timing advance value for communication between base station BS₂ and UE₂ (TA₂) that has been derived from TA₁. The paging indicator may be transmitted by UE₁ over the PC5 air interface either on sidelink resources or on downlink resources, according to UE₂'s expectation. In this example, the paging indicator is received by UE₂ in point G′. Now, UE₂ is expected to pick up the subsequent paging message transmitted by its serving base station BS₂ at the right point in time (e.g., after a relative amount of time tₚ). The paging message is received by UE₂ in point H′. It can now be processed, and a matching paging record can be found. Thus, further activities (such as random access attempts to base station BS₂) can be initiated.

The points D′ and E′ in FIG. 7 represent a simplified random access procedure (“2-Step RACH”) with only two messages. In some embodiments a random access procedure consists of in total four messages (“4-Step RACH”) that are exchanged between UE₁ and BS₂. We further propose to enhance the value range for the information element “establishment cause” that may for example be used in the RRC Connection Setup message (in case of 4G-LTE, this is the third message exchanged during the “4-Step RACH” random access procedure, not shown in FIG. 7) in order to enable UE₁ to signal to base station BS₂ that the purpose of this random access attempt is to find out about another mobile communication device's timing advance (TA) in its vicinity according to the paging method disclosed in this invention. The new value for the “establishment cause” could for instance be set to “timing-advance-for-PCS-paging” (or something similar). A base station receiving an RRC Connection Setup message with the “establishment cause” set to such new value, would know that the aim of this random access procedure is not to set-up bearers between UE₁ and the core network for imminent communication. It would consequently take away some processing burden from the base station. It would also be helpful in suppressing load balancing operations (if there are any).

A second aspect of the invention concerns identifying a neighbour relationship.

Using the known “D2D ProSe direct discovery” procedure would be one option to detect proximity between two mobile communication devices. However, this procedure comes along with an exchange of messages over the PC5 air interface.

In the present scenario, the objective is to let the second mobile communication device stay in sleep mode for as long as possible. Thus, it is not envisaged to let the second mobile communication device engage in any extensive exchange of messages with potential neighbours via the PC5 air interface.

Consequently, for the proposed method to work satisfactorily, the first mobile communication device needs to be provisioned by the network with paging occasions applicable for potential second mobile communication devices (in a given location). The infrastructure will need to maintain a data base for this either in the RAN (if the second mobile communication device in question is residing in RRC_INACTIVE mode of operation, for RAN initiated paging) or in the CN (if the second mobile communication device in question is residing in RRC_IDLE mode of operation, for CN initiated paging).

According to this aspect of the invention, proximity between two mobile communication devices can be detected by the first mobile communication device based on network configuration. It is proposed to include geographical parameters determined or predicted on infrastructure side (“location data”) in the configuration data. The configuration process itself is discussed in more detail in context with the third aspect of the invention described below.

With regard to geographical parameters, a location on Earth may be expressed in terms of latitude and longitude. Latitude (which may be abbreviated as Lat, φ, or phi) is the angle between the equatorial plane and a line from the centre of the reference ellipsoid, which approximates the shape of Earth to account for flattening of the poles and bulging of the equator. Lines joining points of the same latitude are called parallels, which trace concentric circles on the surface of the Earth, parallel to the equator. The north pole is 90° N; the south pole is 90° S. The 0° parallel of latitude is designated the equator, the fundamental plane of all geographic coordinate systems. The equator divides the globe into northern and southern hemispheres. Longitude (which may be abbreviated as Long, λ, or lambda) is the angle east or west of a reference meridian between the two geographical poles to another meridian that passes through an arbitrary point. All meridians are halves of great circles and are not parallel. They converge at the north and south poles. A line passing to the rear of the Royal Observatory, Greenwich (near London in the United Kingdom) has been chosen as the international zero-longitude reference line, the Prime Meridian. Places to the east are in the eastern hemisphere, and places to the west are in the western hemisphere. The antipodal meridian of Greenwich is both 180° W and 180° E.

Table 1 shows how an example location can be expressed in two different ways, or formats. The second row of Table 1 illustrates latitude and longitude in decimal value format. The third row illustrates the same latitude and longitude in degree, minute, and second format. Each data format can be easily translated, or converted, into the other. In combination Latitude and Longitude values allow specification of any arbitrary position of a point on the surface of the Earth. They may be complemented with an additional altitude value, which is used to specify the position of a point above the mean sea level (not shown in Table 1 for sake of simplicity). The geographical parameters, as used in this invention, may consist of any combination of latitude, longitude, and altitude in any format.

TABLE 1

| | Decimal | Degree-Minute-Second |
|---|---|---|
| Latitude (ϕ) | 52.264667 North | 52° 15′ 52.80″ North |
| Longitude (λ) | 10.523776 East | 10° 31′ 25.59″ East |

Further with regard to geographical parameters, proximity between two mobile communication devices may be defined by means of a point of reference and a maximum allowable distance. For instance, if the first mobile communication device finds by comparing output data from a global navigation satellite system (GNSS) receiver or similar position determination module with the location information it has been configured with for the inventive method that it is approaching a given location (or entering an area surrounding a given point of reference), then an event of proximity detection has occurred. In this case the first mobile communication device may begin to transmit the paging indicator according to its configuration to one or more second mobile communication devices, that the network assumes to be in vicinity of the first mobile communication device. Of course, in doing so the first mobile communication device is required to take all the other configuration parameters it has received in the set of configuration data (e.g., relating to timing requirements, resources to be used on the PC5 air interface, and so on) into account as well.

A third aspect of the invention relates to configuring a first mobile communication device.

Two configuration options for the inventive method are described. In both options a set of configuration data is transmitted from the network to the first mobile communication device in subframe n. The set of configuration data may refer to a subframe (n+x) that appears at a later point in time (if x≥1) as well as exactly the same subframe (n) in which it is received (if x=0) by the first mobile communication device. Alternatively, the configuration data may also contain a subframe pattern and thus may refer to more than one subframe that will appear at later points in time.

According to one embodiment of the present invention the set of configuration data contains location information, such as a (list of) geographical parameter(s), or a (list of) Cell-ID(s), and alike (generally referred to as “location data”). The geographical parameters may have been determined or predicted on infrastructure side or read from a data base.

According to a further embodiment of the present invention the set of configuration data contains timing information, which may comprise a relative time indication (e.g., “This configuration is applicable in three subframes from now.” or “This configuration is applicable 3 milliseconds from now.”) and/or a timing reference (e.g., in form of a (list of) base station identifier(s)), and alike. The (list of) base station identifier(s) may be useful for UE₁ to calculate the exact point in time for transmitting the paging indicator if UE₁ and UE₂ are camping on different base stations in a heterogeneous network (HetNet) deployment (for instance, consisting of a macro cell layer and a small cell layer). By means of the base station identifier UE₁ could find out the timing advance (TA) applicable for the base station providing cell coverage for UE₂ (e.g., after having performed a random access on said cell). As the frame timing of the cell serving UE₁ may be different from the frame timing in the cell that UE₂ is camping on, the TA determined by performing a random access procedure on the other cell can then be used by UE₁ to calculate the exact point in time for transmitting the paging indicator to UE₂. Details about this random access are part of the first aspect described above (cf. description of FIG. 7).

A first configuration option is shown in FIG. 8.

The configuration data is transmitted from the network to the first mobile communication device at physical layer (i.e. on PDCCH) by means of downlink control information (DCI) elements (cf. FIG. 8). The DCI elements may be enhancements/modifications of already existing DCI elements or newly designed ones to support the configuration method.

The DCIs may be addressed to a particular first mobile communication device (using an individual RNTIs) or a group of first mobile communication devices (using a newly defined Group-RNTI). In FIG. 8, subframe 1 is the one transmitted by the infrastructure side (base station). Subframe 2 represents the same subframe as received by the first mobile communication device. The “C”-field within the CCR indicates that the configuration data is transmitted from the network to the first mobile communication device by means of DCI elements.

A second configuration option is illustrated in FIG. 9.

The configuration data is transmitted from the network to the first mobile communication device at RRC layer by means of RRC signalling (cf. FIG. 9). For this RRC signalling existing downlink RRC messages could be enhanced/modified or a completely new RRC message to support the configuration method could be designed. One type of RRC message is addressed to all UEs in coverage of a given radio cell (broadcast RRC signalling), while another type of RRC message is addressed to single UEs (dedicated RRC signalling). The method of the invention is not restricted to any of these two types of RRC messages. According to this invention the network may freely choose whether to use broadcast RRC signalling or dedicated RRC signalling to get the set of configuration data across the Uu air interface to one or more first mobile communication devices.

In FIG. 9, subframe 1 is the one transmitted by the infrastructure side (base station). Subframe 2 represents the same sub frame as received by the first mobile communication device. The “C”-field within the SCR indicates that the configuration data is transmitted from the network to the first mobile communication device by means of (broadcast or dedicated) RRC signalling.

Signalling at physical layer (option 1, according to FIG. 8) is a little bit faster, but not as reliable as RRC signalling (in terms of encryption as well as in terms of error correction). Signalling at RRC layer (option 2, according to FIG. 9) allows the configuration data to be more extensive and offers more flexibility to structure the inventive payload. For our main scenario, in which the second mobile communication device is an IoT-device that needs to be woken up, configuration option 2 is the preferred choice.

A fourth aspect of the invention relates to paging over the PC5 air interface.

According to this aspect of the invention the two separated pieces of information needed during the paging process are transmitted from two different entities: First, the paging indicator (PI) is sent from UE₁ to UE₂, then the paging message (PM) is sent from a base station to UE₂. While the latter (i.e. the PM) is always transmitted in the SCR of a downlink sub frame, the transmission of the PI by UE₁ may occur either on sidelink radio resources or on downlink radio resources as will be explained in the following section.

FIG. 10 depicts the case where UE₁ uses sidelink resources for transmitting the PI over the PC5 air interface. The sidelink resources (with respect to frame timing and frequency allocation) are chosen in such a way that they chronologically and frequency-wise fall together with those downlink resources in which UE₂ would normally expect the PDCCH to occur from its serving base station, i.e. if the PM is sent in subframe (n+x), also the PI has to arrive at UE₂ in sub frame (n+x). The remains of the sidelink resource grid (i.e. apart from the resources used for the inventive PI) in subframe 1 may or may not be left blank. Subframes 1 and 2 are containing the PI. Subframe 1 is transmitted by UE₁ and subframe 2 represents the reception of the same subframe by UE₂. UE₁ may choose to transmit this sidelink subframe in parts of the resource grid, where UE₂ would normally expect a downlink subframe to arrive (from its base station). Subframes 3 and 4 are containing the PM. Subframe 3 is transmitted by the base station and subframe 4 represents the reception of the same subframe by UE₂. The PM is located in the SCR, as expected by UE₂.

FIG. 11 depicts the case where UE₁ uses downlink resources for transmitting the PI over the PC5 air interface. That means, UE₁ is emulating base station functionality for this part of its operation. In one embodiment emulating base station functionality may require UE₁ to turn on a second TX chain (at least) for a limited amount of time. The downlink resources (with respect to frame timing and frequency allocation) are chosen in such a way that they chronologically and frequency-wise fall together with those downlink resources in which UE₂ would normally expect the PDCCH to occur from its serving base station, i.e. if the PM is sent in subframe (n+x), also the PI has to arrive at UE₂ in subframe (n+x). The remains of the downlink resource grid (apart from the resources used for the inventive PI) in subframe 1 may or may not be left blank.

Subframes 1 and 2 are containing the PI. Subframe 1 is transmitted by UE₁ and subframe 2 represents the reception of the same sub frame by UE₂. UE₁ may choose to transmit this downlink subframe in parts of the resource grid, where UE₂ would normally expect a downlink subframe to arrive (from its base station). Subframes 3 and 4 are containing the PM. Subframe 3 is transmitted by the base station and subframe 4 represents the reception of the same sub frame by UE₂. The PM is located in the SCR, as expected by UE₂.

In both FIGS. 10 and 11, the subframe that UE₂ perceives at point in time (n+x), is the superposition of subframe 1 (transmitted by UE₁) and subframe 3 (transmitted by the base station). This composed “downlink subframe” is containing both the PI in the CCR and the PM (for example, in the SCR), as expected by UE₂.

A fifth aspect of the invention relates to refining resource coordination.

The two FIGS. 10 and 11 also show a portion in the CCR of subframe 3 tagged with “B”. According to one embodiment of the present invention, this part of the downlink resource grid is ideally blanked by the base station serving UE₂ (i.e. it is not used) in order to avoid any resource conflicts between subframe 3 transmitted over the Uu air interface and subframe 1 transmitted over the PC5 air interface. Without such blanking, interference might occur at various UEs in vicinity of the two mobile communication devices UE₁ and UE₂, in particular at UE₂.

The “B” portion of the CCR may, for example, consist of one or more resource elements (REs) or resource blocks (RBs) assigned to the PDCCH of subframe 3, in which the paging indicator (e.g., in form of a DCI whose cyclic redundancy check, CRC, part is scrambled with a paging-RNTI) would normally be sent.

A sixth aspect of the invention relates to a timing relation across subframes.

The sixth aspect is concerned with a timing relation that goes beyond subframe boundaries. That means, unlike in present deployments, the control channel region for transmitting the PI and the shared channel region for transmitting the subsequent PM are no longer residing in the same subframe. Details of this aspect are shown in FIG. 12. In the previous figures Δt_{c} was used to indicate the amount of time between reception of the paging configuration by UE₁ (in sub frame n) and the relevant subframe (n+x) in which the paging process is performed. In contrast to this FIG. 12 shows Δtₚ as the time duration between reception of subframe (n+x) and subframe (n+y) with x<y.

In this scenario UE₂ needs to know that PI and PM are not received in the same subframe. The offset Δtₚ could be part of the configuration process according to the third aspect of the present invention.

Preferred aspects of the invention include:

(i) a method for enabling a first mobile communication device to assist in a paging procedure for paging a second mobile communication device;

especially wherein the paging procedure comprises at least one of the following:

receiving a paging indicator from the first mobile communication device over a direct device-to-device air interface; and receiving a paging message from a base station;

and further wherein the transmission of the paging indicator is configurable by a base station and the paging indicator is sent when at least one of the following criteria is met:

a location requirement (the first mobile communication device has detected proximity to the second mobile communication device);

a timing requirement (the first mobile communication device has detected a paging opportunity for/reachability of the second mobile communication device).

and further wherein the novel paging procedure further comprises at least one of the following:

generating in the first mobile communication device a location fix;

comparing by the first mobile communication device said location fix with configuration data received from a base station;

determining by the first mobile communication device a transmission time for sub frame transmission over a direct device-to-device air interface to the second mobile communication device;

including by the first mobile communication device in a subframe transmission to the second mobile communication device a paging indicator.

Note: The order of “location check” and “timing check” was chosen arbitrarily. It could be the other way around as well.

A further aspect is wherein determining the transmission time further comprises at least one of the following:

performing by the first mobile communication device a random access to the base station serving the second mobile communication device;

receiving by the first mobile communication device the timing advance value from the base station serving the second mobile communication device;

calculating by the first mobile communication device from the timing advance value received from the base station serving the second mobile communication device a timing offset between the first and the second mobile communication device; using by the first mobile communication device the timing offset to determine the exact point in time for sub frame alignment between the first and the second mobile communication device; and

transmitting by the first mobile communication device at the exact point in time a subframe from the first to the second mobile communication device.

The invention also provides a mobile communication device equipped with means to realize the described paging procedure.

The invention provides infrastructure equipment having means to realize the paging procedure.

1. A method of performing a paging action directed to a second user equipment, UE, device in a mobile communications system, the method comprising:
transmitting a configuration message from a first base station to a first UE device to configure the first UE device to transmit a paging indicator at a predetermined time if it is determined that a geographical condition is satisfied; and
transmitting a paging message from one of the first base station and a second base station to the second UE device after the paging indicator has been transmitted.

2. The method according to claim 1, wherein the geographical condition is the second UE device being located within a predetermined proximity to the first UE device.

3. The method according to claim 1, wherein the first UE device determines if the geographical condition is satisfied by analysing global navigation satellite system information.

4. The method according to claim 1, wherein the paging indicator is transmitted over an inter-UE device sidelink.

5. The method according to claim 1, wherein the paging indicator is transmitted by the first UE device acting as a base station emulator.

6. The method according to claim 1, wherein the configuration message includes location information and/or timing information.

7. The method according to claim 6, wherein the configuration information is transmitted to the first UE device by means of downlink control information.

8. The method according to claim 6, wherein the configuration information is transmitted to the first UE device by means of radio resource control signalling.

9. The method according to claim 1 wherein the first base station does not transmit in a part of a downlink resource grid which will be used by the first UE device to transmit the paging indicator.

10. The method according to claim 1, wherein the second UE device is informed of a time difference between a subframe carrying the paging indicator received from the first UE device and a subframe carrying the paging message received from the first or second base station.

11. The method according to claim 1 wherein the first UE device determines its position, compares its determined position with configuration data received from the first base station, and determines a transmission time for a transmission of the paging indicator.

12. The method according to claim 11, wherein in order to determine the transmission time, the first UE device performs a random access to the second base station serving the second UE, receives from the second base station a timing advance parameter, calculates a timing offset between the first UE device and the second UE device, determines a point in time for subframe alignment between the first and second UE devices using the timing offset and transmits at the point in time a subframe containing the paging indicator.

13. The method according to claim 1, further comprising transmitting by the first UE device the paging indicator to the second UE device.

14. A user equipment, UE, device adapted to receive a paging indicator from a further UE device over a first air interface and in response to the paging indicator to perform configuration actions to receive a subsequent paging message associated with the paging indicator from a base station over a second air interface.

15. A method of performing a paging action directed to a second user equipment, UE, device in a mobile communications system, the method comprising:
transmitting a configuration message from a first base station to a first UE device to configure the first UE device to transmit a paging indicator at a predetermined time if it is determined that a geographical condition is satisfied;
transmitting by the first UE device the paging indicator to the second UE device; and
transmitting a paging message from one of the first base station and a second base station to the second UE device after the paging indicator has been transmitted.

16. The method according to claim 2, wherein the first UE device determines if the geographical condition is satisfied by analysing global navigation satellite system information.

17. The method according to claim 2, wherein the paging indicator is transmitted over an inter-UE device sidelink.

18. The method according to claim 2, wherein the paging indicator is transmitted by the first UE device acting as a base station emulator.

19. The method according to claim 2, wherein the configuration message includes location information and/or timing information.

20. The method according to claim 19, wherein the configuration information is transmitted to the first UE device by means of downlink control information.
